(19) United States
(12) Patent Application Publication
(10) Pub. No.: US 2004/0082705 A1
(43) Pub. Date: Apr. 29, 2004

(54) One-pot water-resistant polyvinyl acetate copolymer aqueous emulsion and it preparation

(75) Inventors: Jing-Jin Tsai, Miaoli (TW); Li-Shing Lin, Miaoli (TW); Gan-Dar Fan, Miaoli (TW)

Correspondence Address: BACON & THOMAS, PLLC, 625 SLATERS LANE, FOURTH FLOOR, ALEXANDRIA, VA, 22314

(73) Assignee: CHANG CHUN PETROCHEMICAL CO., LTD., Taipei (TW)

(21) Appl. No.: 10/606,901

(22) Filed: Jun. 27, 2003

(30) Foreign Application Priority Data
Oct. 24, 2002 (TW) 091124723

(51) Int. Cl. C08J 3/00

(52) U.S. Cl. 524/503

(57) ABSTRACT

The present invention relates to a one-pot water-resistant polyvinyl acetate copolymer aqueous emulsion and its preparation. The one-pot water-resistant polyvinyl acetate copolymer aqueous emulsion of the present invention is prepared from emulsion co-polymerization of vinyl acetate monomer and an unsaturated functional silicon-containing monomer at atmospheric pressure to prepare a one-pot self-cross-linkable emulsion.

The one-pot water-resistant polyvinyl acetate copolymer aqueous emulsion of the present invention will be dried and self cross-linked at ambient temperature without heating or using cross-linking agent to render the emulsion a water resistance. Thereby, the one-pot water-resistant polyvinyl acetate copolymer aqueous emulsion of the present invention possesses an improved operation.

### FIELD OF THE INVENTION

The present invention relates to a one-pot water-resistant polyvinyl acetate copolymer aqueous emulsion and its preparation. The one-pot water-resistant polyvinyl acetate copolymer aqueous emulsion of the present invention is prepared from emulsion co-polymerization of vinyl acetate monomer and an unsaturated functional silicon-containing monomer at atmospheric pressure to prepare a one-pot self-cross-linkable emulsion.

### BACKGROUND OF THE INVENTION

Polyvinyl acetate polymer is thermoplastic type high molecular weight polymer. Although it had been discovered for a long time, it is widely used till emulsion type polyvinyl acetate being developed in 1940's. At present, polyvinyl acetate is consumed exceeding several million tones yearly worldwide. Polyvinyl acetate resin has been widely used as a gluing agent for wooden material and furniture due to heating is not needed in using. Also, polyvinyl acetate has excellent ability for gluing cellulose and the other material, it has been widely used in the process for bonding or stiffening of paper matrix and cellulose.

For use as a gluing agent for wooden material, the polyvinyl acetate is generally used in the form of homo-polymer emulsion, which exhibits excellent adhesion to wooden material. However, the polyvinyl acetate emulsion adhesive is very sensitive to water so that its water resistance is insufficient. Therefore, it is needed to improve the adhesive strength and water resistance of polyvinyl acetate through the use of co-polymerization. In industries, examples of monomers used to co-polymerize with polyvinyl acetate include, for example, dialkyl maleate such as di-butyl maleate; alkyl acrylate such as butyl acrylate. Although the above-mentioned copolymers can improve certain properties of the homo-polymer, their heat resistance and adhesive strength become weak and their long curing time results in poor operation.

Although vigorously stirring the polyvinyl acetate at elevated temperature results in formation of grafting structure of the polyvinyl acetate and then improves a mechanical property. But its water resistance could not be improved. Polyvinyl acetate resin is generally co-polymerized to render the resultant copolymer more functional groups and cross-linkable group so that the copolymer could be further cross-linked to form a high rigid cured article having a three-dimension structure and thus the cured article is rendered with improved water resistance and heat resistance. Common used N-hydroxymethylacrylamide is a self cross-linkable monomer. A water resistance of a copolymer prepared from N-hydroxymethylacrylamide can be increased only if addition acidic salt into the co-polymer and then heating and curing (please refer to Handbook of Adhesive, 3^{rd} editor, 1990). In addition, Armour et. al, U.S. Pat. No. 3,563,851 discloses an adhesive composition, wherein acidic metal salt curing agents are added to the aqueous emulsion of copolymer of vinyl acetate and acrylates. After the composition being heated, it has improved water resistance.

Although the above references and patent publications describe the use of co-polymerization to improve physical properties of copolymer. But there is still a problem of insufficient adhesion or a curing agent is needed to improve physical properties. Such a two-pot composition is not only unstable in storage but also complex in operation. The present inventors have conducted an investigation on polyvinyl acetate under the considerations of disadvantages of poor operation of polyvinyl acetate and equipment. And results the present inventors have developed a polyvinyl acetate copolymer, which can self cross-link at ambient temperature without heating to obtain a good excellent water resistance and thus completed the present invention.

### OBJECTS OF THE PRESENT INVENTION

One objects of the present invention is to provide a one-pot polyvinyl acetate aqueous emulsion having improved operation. The emulsion can self cross-link at ambient temperature without heating nor curing agent to obtain a good excellent water resistance.

The other object of the present invention is to provide a method for preparing the one-pot polyvinyl acetate aqueous emulsion, which comprises emulsion polymerization of vinyl acetate and silicon monomer containing ethylenically unsaturated functional group in aqueous medium at an atmosphere pressure to produce one-pot self cross-linkable polyvinyl acetate emulsion.

### DETAIL DESCRIPTION OF THE PRESENT INVENTION

The present invention provide a one-pot polyvinyl acetate aqueous emulsion comprises the polyvinyl acetate copolymer of the following formula (I):

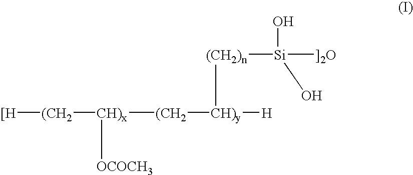

wherein:

n represents an integer of from 0 to 5;

a ratio of x/y is from 4 to 1000, preferably from 4 to 190, most preferably 15 to 190;

a molecular weight of the polyvinyl acetate copolymer is from 1,000 to 800,000, preferably from 50,000 to 600,000, most preferably from 10,000 to 500,000.

The x repeating units of —(CH₂—CH(OCOCH₃)—) and y repeating units of —(CH₂—CH)— in the formula (I) are either random polymerized or block polymerized or a combination thereof.

The one-pot polyvinyl acetate aqueous emulsion of the present invention (hereinafter sometimes simply refer to polyvinyl acetate) would not self cross-link in aqueous medium but will self cross-link after evaporation of water. Therefore the one-pot polyvinyl acetate aqueous emulsion of the present invention can be cured without neither heating nor addition of cross-linking agent or curing catalyst. Thus, the one-pot polyvinyl acetate aqueous emulsion of the present invention has no storage issue as long as it is in an aqueous medium. The one-pot polyvinyl acetate aqueous emulsion of the present invention is still stable after standing at ambient temperature for at least 6 months. Also, the aqueous emulsion could self cross-link after evaporation of water. Therefore, in practice of the aqueous emulsion of the present invention, it does not need crosslinking agent and catalyst, which are necessary for conventional two-pot emulsion. Furthermore, since the aqueous emulsion of the present invention could self cross-link without heating, an operation condition could be improved.

Moreover, since a film formed by drying the aqueous emulsion of the present invention exhibits excellent strength and water resistance, physical properties of a product prepared by using the aqueous emulsion will be increased and its operation is improved.

The self cross-linking mechanism of the one-pot polyvinyl acetate aqueous emulsion of the present invention will be apparent from the following description regarding its preparation.

The present invention also relates to a method for preparing a one-pot polyvinyl acetate aqueous emulsion, which comprises reacting vinyl acetate with silicon monomer containing ethylenically unsaturated functional group represented by the following formula (II) in the presence of catalyst in aqueous medium at an atmosphere pressure:

CH₂═CH—(CH₂)ₙ—Si(R¹)ₘ(R₂)₃₋ₘ (II)

wherein R¹=C₁₋₆ alkyl group;

R²=C₁₋₄₀ alkoxy group, preferably C₁₋₁₂ alkoxy group;

n=0 to 5;

m=0 to 3.

In the above method, the silicon monomer containing ethylenically unsaturated functional group is 0.01 to 15%, preferably 0.5 to 3% based on the total weight of vinyl acetate and the silicon monomer. The reaction is conducted at a temperature of from 55 to 90° C., preferably from 60 to 80° C., at an atmosphere pressure for 4 to 8 hours. After the reaction is completed, the resultant mixture is cured at a temperature of from 65 to 95° C., preferably from 70 to 90° C., for 2 to 3 hours.

The terms “C₁₋₆ alkyl group” and “C₁₋₄₀ alkoxy group” used herein include a straight and branched one.

Examples of the silicon monomer containing ethylenically unsaturated functional group include, for example, but not limited to, vinyltrimethoxysilane, vinyltriethoxysilane, vinyltriisopropoxysilane, vinylmethyldimethoxysilane, vinyltributoxysilane, vinylethyldipropoxysilane, vinyltripentoxysilane, vinyltrihexyloxysilane, and the like.

The catalyst used in the present method can be peroxide, for example, persulfate such as ammonium persulfate, sodium persulfate, potassium persulate, hydrogen peroxide, benzoyl peroxide, permanganate, and the like.

The aqueous medium used in the present method can be any aqueous medium, as long as it does not interfere with the proceeding of the reaction.

The following schemes A and B further illustrate reaction of the water resistant polyvinyl acetate aqueous emulsion:

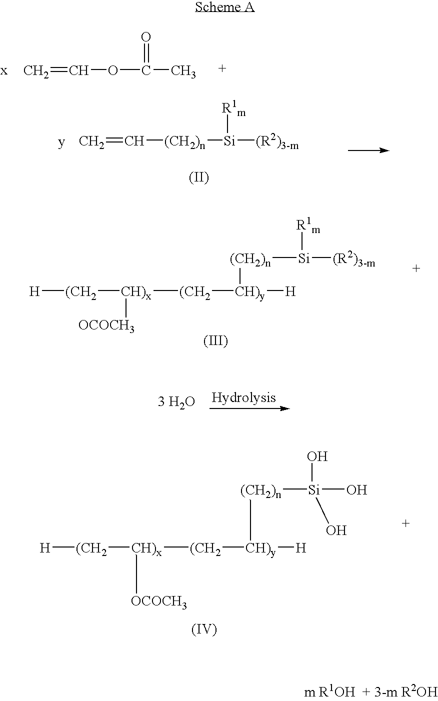

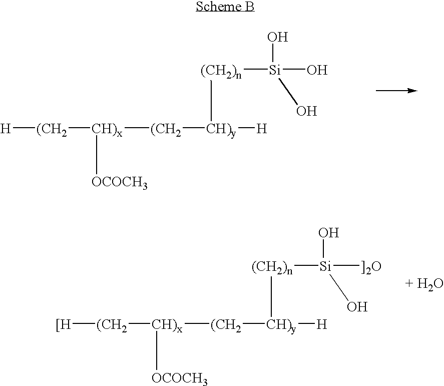

According to the above Schemes, it is known that vinyl acetate is co-polymerized with silicon monomer containing ethylenically unsaturated functional group to form a silicon-containing polyvinyl acetate copolymer of formula (III). The copolymer (III) is then hydrolyzed in the presence of water to form a silicon- and hydroxy-containing polyvinyl acetate copolymer of formula (IV). The silicon- and hydroxy-containing polyvinyl acetate copolymer of formula (IV) is then self cross-linked after evaporation of water to form the present polyvinyl acetate of formula (I), which is water-resistant. In other words, the emulsion of the present invention is the emulsion of the silicon- and hydroxy-containing polyvinyl acetate copolymer of formula (IV) in aqueous medium, which is water-resistant when it is dried.

Further, from the Scheme B it is known that although the copolymer (III) is hydrolyzed to form copolymer (IV) in the presence of water, the copolymer would not be self cross-linked due to the presence of water. Therefore, the polyvinyl acetate aqueous emulsion of the present invention has long operation time and shelf time. The polyvinyl acetate aqueous emulsion of the present invention will be self cross-linked after evaporation of water without adding of other metal catalyst nor heating. The one-pot polyvinyl acetate aqueous emulsion of the present invention has a long operation time. It would not be cured rapidly during an operation time of from about 2 to 6 hours. Thus, there is no curing problem in short time during operation.

The one-pot polyvinyl acetate aqueous emulsion of the present invention is still stable after standing at a temperature of 25° C. for at least 6 months. Thus comparing with a conventional two-pot polyvinyl acetate emulsion, the one-pot polyvinyl acetate aqueous emulsion of the present invention has excellent storage stability.

The present invention will further be explained through the following Examples. However, it should be understood by those skilled in the art that the Examples are only used to illustrate the present invention without limiting the scope of the present invention.

### EXAMPLE 1

In emulsion polymerization reactor an aqueous solution of 10% polyvinyl alcohol (980 grams) having a degree of polymerization (DP) of 1700 was prepared at atmosphere pressure. In a separate reactor an aqueous solution of 8-10% ammonium persulfate (50 grams) was prepared. Also, a monomer mixture of 900 grams of vinyl acetate monomer and 60 grams of vinyltrimethoxysilane was prepared. The aqueous solution of 10% polyvinyl alcohol (980 grams) was heated to 80° C. in the emulsion polymerization reactor and then 20 grams of the ammonium persulfate solution was added into thereto. The resultant mixture was stirred to form a uniform mixture. The above monomer mixture and 20 grams of the ammonium persulfate solution were added dropwise to the uniform mixture in rates of 3 ml/min and 0.07 g/min, respectively. The reaction was carried out at a temperature of 80° C. for 5 hours. After the reaction is completed, the temperature of the reaction mixture was raised to 90° C., the remaining ammonium persulfate solution was then added to the reaction mixture and cured for 1.5 hours. After aging, the resultant mixture was allowed to room temperature to obtain the emulsion of the silicon- and hydroxy-containing polyvinyl acetate copolymer of formula (IV) in aqueous medium of the present invention.

The emulsion of the silicon- and hydroxy-containing polyvinyl acetate copolymer of formula (IV) in aqueous medium of the present invention was tested its viscosity, solid content, and pH value according to the methods of JIS-K6828. Moreover, a rigid film produced by drying and cross-linking the emulsion was tested its water resistance order according to EN204 and tested its peeling ability after impregnating in water (water resistance) according to CNS 1349. The data was compared with a commercial product (a polyvinyl acetate emulsion sold by Chang Chun Petrochemical Co., Ltd. under catalog number AE-150) and the result is shown in the following Table 1.

### EXAMPLE 2

An emulsion of the silicon- and hydroxy-containing polyvinyl acetate copolymer of formula (IV) in aqueous medium of the present invention was produced according to the method of Example 1, except substituting vinyltriisopropoxysilane for vinyltrimethoxysilane. The resultant emulsion was tested its various properties according the methods mentioned in Example 1 and its result was also shown in Table 1.

TABLE 1

| | | | Peeling | | |
|---|---|---|---|---|---|
| | | | ability after | | Order of |
| | | | impregnating | pH | water |
| | Viscosity | Solid content | in water | value | resistance |
| Example 1 | 15,000 cps | 52% | No peel off | 5.1 | >D3 |
| Example 2 | 13,000 cps | 52.2% | No peel off | 4.9 | >D3 |
| Commercial | 11,400 cps | 50.2% | Peel off | 5.0 | >D2 |
| product B | | | about 21 mm | | |

### EXAMPLES 3-6

Emulsions of the silicon- and hydroxy-containing polyvinyl acetate copolymer of formula (IV) in aqueous medium of the present invention was produced according to the method of Example 1, except substituting vinyltriisopropoxysilane for vinyltrimethoxysilane and the weight ratio of vinyl acetate monomer/vinyltriisopropoxysilane monomer was changed to 924/40, 884/80, 864/110, and 824/140 respectively in Examples 3 to 6. The resultant emulsions were tested their various properties according the methods mentioned in Example 1 and its result was also shown in Table 2.

TABLE 2

| | | | Peeling | | |
|---|---|---|---|---|---|
| | | | ability after | | Order of |
| | | | impregnating | pH | water |
| | Viscosity | Solid content | in water | value | resistance |
| Example 3 | 11,000 cps | 52.2% | No peel off | 4.9 | >D3 |
| Example 4 | 12,400 cps | 51.2% | No peel off | 5.0 | >D3 |
| Example 5 | 15,000 cps | 51.6% | No peel off | 4.8 | >D3 |
| Example 6 | 14,000 cps | 51.8% | No peel off | 4.8 | >D3 |

### EXPERIMENT EXAMPLE 1

The emulsions produced from Example 1-6 are each tested its viscosity stability at 25° C. and 40° C., respectively, according to JIS-K6828. The results are shown in Table 3.

TABLE 3

| | Initial viscosity | Viscosity @ 25° C. | Viscosity @ 40° C. |
|---|---|---|---|
| | (cps) | for 2 weeks (cps) | for 2 weeks (cps) |
| Example 1 | 13,000 | 14,000 | 32,000 |
| Example 2 | 11,400 | 14,400 | 31,000 |
| Example 3 | 11,000 | 14,000 | 35,000 |
| Example 4 | 12,400 | 16,000 | 32,000 |
| Example 5 | 15,000 | 15,500 | 33,000 |
| Example 6 | 14,000 | 14,400 | 35,000 |

From the above Table 3, it is known that the one-pot polyvinyl acetate aqueous emulsion according to the present invention exhibits excellent stability and water resistance.

What is claimed is:

1. A one-pot polyvinyl acetate copolymer aqueous emulsion, wherein the polyvinyl acetate copolymer has the following formula (I): 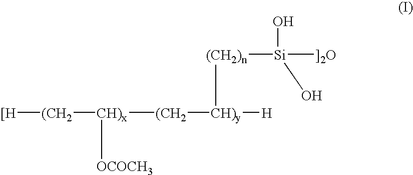
wherein:
n represents an integer of from 0 to 5;
a ratio of x/y is from 4 to 1000;
a molecular weight of the polyvinyl acetate copolymer is from 1,000 to 800,000.

2. The one-pot polyvinyl acetate copolymer aqueous emulsion according to claim 1, wherein the ratio of x/y is from 4 to 190.

3. The one-pot polyvinyl acetate copolymer aqueous emulsion according to claim 1, wherein the ratio of x/y is from 15 to 190.

4. A method for producing the one-pot polyvinyl acetate copolymer aqueous emulsion according to claim 1, which comprises the steps of:
reacting vinyl acetate with silicon monomer containing ethylenically unsaturated functional group represented by the following formula (II) in the presence of catalyst in aqueous medium at an atmosphere pressure:
CH₂═CH—(CH₂)ₙ—Si(R¹)ₘ(R²)₃₋ₘ (II)
wherein R¹=C₁₋₆ alkyl group;
R²=C₁₋₄₀ alkoxy group, preferably C₁₋₁₂ alkoxy group;
n=0 to 5;
m=0 to 3;
to produce the aqueous emulsion of the polyvinyl acetate of following formula (I): 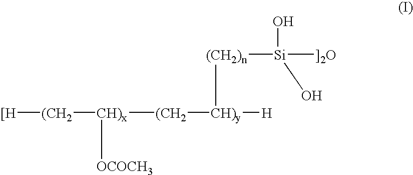
wherein:
n represents an integer of from 0 to 5;
a ratio of x/y is from 4 to 1000;
a molecular weight of the polyvinyl acetate copolymer is from 1,000 to 800,000;
wherein the silicon monomer containing ethylenically unsaturated functional group is 0.01 to 15% based on the total weight of vinyl acetate and the silicon monomer.

5. The method according to claim 4, wherein the reaction is carried out at a temperature of from 55 to 90° C.

6. The method according to claim 4, which further comprises a step of aging the copolymer at a temperature of from 65 to 95° C.

7. The method according to claim 4, wherein the catalyst is persulfate.

8. The method according to claim 7, wherein the persulfate is selected from the group consisting of ammonium persulfate, sodium persulfate, potassium persulfate, and a combination thereof.

9. The method according to claim 4, wherein the catalyst is peroxide.

10. The method according to claim 9, wherein peroxide is selected from the group consisting of hydrogen peroxide, benzoyl peroxide, and a combination thereof.

11. The method according to claim 4, wherein the silicon monomer containing ethylenically unsaturated functional group is 0.5 to 3% based on the total weight of vinyl acetate and the silicon monomer.
